(19) United States
(12) Patent Application Publication
(10) Pub. No.: US 2009/0279022 A1
(43) Pub. Date: Nov. 12, 2009

(54) MICRO REFLECTION-TYPE LIQUID CRYSTAL DISPLAY

(75) Inventors: YI-CHUN WU, Hualien County (TW); CHUN-CHI CHI, Taichung County (TW); CHUNG-HUI HU, Yunlin County (TW)

Correspondence Address: WPAT, PC, 7225 BEVERLY ST., ANNANDALE, VA, 22003, US

(73) Assignee: WINTEK CORPORATION, TAICHUNG, TW (TW)

(21) Appl. No.: 12/436,301

(22) Filed: May 6, 2009

(30) Foreign Application Priority Data
May 6, 2008 (TW) 097116597

(51) Int. Cl. G02F 1/1347; G02F 1/13363; G02F 1/1335

(52) U.S. Cl. 349/75; 349/119; 349/96

(57) ABSTRACT

The present invention discloses a micro reflection-type liquid crystal display (LCD) using a step difference resulting from the existing array processing and a liquid crystal cell comprising liquid crystal molecules being aligned in parallel to perform optical compensation according to the difference between optical slow axes on orthogonal optical compensation films. In a compensation system comprising orthogonal polarizers, an equivalent retardation is acquired according to the differences between the slow axes on the optical compensation films and the alignment orientation of the liquid crystal molecules when the liquid crystal cell is driven or not to determine the optimal dark/bright state. Moreover, the optimal dark state can be achieved at the same driving voltage under both the reflection mode and the transmission mode. Thereby, the present invention achieves improved image contrast and reflectivity without additional processing steps.

### BACKGROUND OF THE INVENTION

1. Field of the Invention

The present invention generally relates to a micro reflection-type liquid crystal display (LCD) and, more particularly, to a micro reflection-type liquid crystal display using a step difference resulting from the existing array processing and a liquid crystal cell comprising liquid crystal molecules being aligned in parallel to perform optical compensation according to the difference between slow axes on optical compensation films and the alignment orientation of the liquid crystal molecules to improve image contrast and reflectivity.

2. Description of the Prior Art

In early years, the conventional transmission-type thin-film transistor liquid crystal display (TFT-LCD), as shown in FIG. 1, comprises a liquid crystal layer 13 disposed between a top substrate 11 and a bottom substrate 12. A top polarizer 14 and a bottom polarizer 15 are disposed respectively on the top substrate 11 and the bottom substrate 12. A backlight (not shown) is further disposed under the bottom polarizer 15. Moreover, a thin-film transistor (not shown) and a storage capacitor 16 corresponding to each of the pixels are disposed on the bottom substrate 12. The storage capacitor 16 comprises a bottom metal layer 161, an insulating layer 162 and a top metal layer 163 that are stacked. On the top substrate 11 is disposed a black matrix covering the storage capacitor 16 and the thin-film transistor to avoid the reduction of the image contrast.

The transmission-type thin-film transistor liquid crystal display (TFT-LCD) is problematic in poor image contrast under the sun light because there is no reflection mechanism to reflect the external light.

In order to overcome such a problem, it has been reported to use a reflection plate comprising a reflection electrode region and a transmission electrode region corresponding to each of the pixels on the bottom substrate to overcome poor image contrast under the sun light, for example, U.S. Pat. No. 6,295,109 entitled “LCD with plurality of pixels having reflective and transmissive regions.” However, the reflection plate leads to reduced aperture ratio with complicated optical design and processing.

Moreover, in U.S. Pat. No. 6,744,480, a scattering layer and a reflection type polarizer such as a dual brightness enhancement film (DBEF) are used in a transmission-type panel. However, this results in image parallax, poor contrast and low reflectivity under a reflection mode.

Therefore, to overcome the problems in the aforementioned prior art references, there is need in providing a micro reflection-type liquid crystal display using optical compensation films and a step difference resulting from the existing array processing to improve image contrast and reflectivity.

### SUMMARY OF THE INVENTION

It is one object of the present invention to provide a micro reflection-type liquid crystal display using a step difference resulting from the existing array processing and a liquid crystal cell comprising liquid crystal molecules being aligned in parallel to perform optical compensation according to the difference between slow axes on optical compensation films and the alignment orientation of the liquid crystal molecules to improve image contrast and reflectivity.

In order to achieve the foregoing object, the present invention provides a micro reflection-type liquid crystal display (LCD), comprising: a first polarizer;
a first optical compensation film disposed on the first polarizer and comprising a first slow axis;
a liquid crystal cell disposed on the first optical compensation film and comprising:
   a first substrate comprising a first alignment film disposed thereon, a plurality of scan lines and a plurality of data lines enclosing a plurality of pixel units, each pixel unit comprising a transmissive region and a reflective region;
   a second substrate, comprising a second alignment film disposed thereon and facing the first alignment film;
   a liquid crystal layer disposed between the first alignment film and the second alignment film, the liquid crystal layer comprising liquid crystal molecules being aligned in parallel, and the first slow axis being perpendicular to the alignment directions of the first and the second alignment films;
a second optical compensation film disposed on the liquid crystal cell and comprising a second slow axis, the second slow axis being parallel with the alignment directions of the first and the second alignment films; and
a second polarizer disposed the second optical compensation film;
wherein the thickness of the liquid crystal layer in the transmissive region is larger than the thickness of the liquid crystal layer in the reflective region, and the phase retardation in the reflective region is from 110 to 310 nm and the phase retardation in the transmissive region is from 200 to 380 nm.

For general rod-like liquid crystal molecules, the equivalent retardation is added when the alignment direction is identical to the slow axis on the retardation film, and is subtracted when the alignment direction and the slow axis on the retardation film are orthogonal. Therefore, the present invention achieves micro reflection-type liquid crystal display (LCD) with both the reflection mode and the transmission mode by the aforesaid approach.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a cross-sectional view of a conventional transmission-type thin-film transistor liquid crystal display (TFT-LCD);

FIG. 2 is a top view of a layout of a sub-pixel of the present invention;

FIG. 3 is a cross-sectional view of a transmissive region in FIG. 2 along 2-2;

FIG. 4 is a cross-sectional view of a reflective region in FIG. 2 along 3-3;

FIG. 5A is a cross-sectional view of a micro reflection-type thin-film transistor liquid crystal display according to a first embodiment of the present invention;

FIG. 5B shows the reflectivity at different voltages under the reflection mode according to the first embodiment of the present invention;

FIG. 5C shows the transmission at different voltages under the transmission mode according to the first embodiment of the present invention;

FIG. 5D shows both the transmission and the reflectivity according to the first embodiment of the present invention;

FIG. 6A and FIG. 6B are cross-sectional views of a micro reflection-type thin-film transistor liquid crystal display according to a second embodiment of the present invention;

FIG. 6C shows the reflectivity at different voltages under the reflection mode according to the second embodiment of the present invention; and

FIG. 6D shows the transmission at different voltages under the transmission mode according to the second embodiment of the present invention.

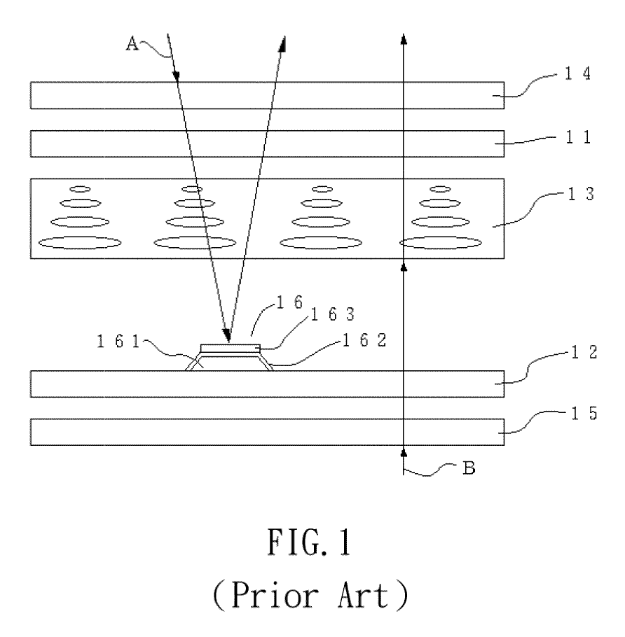

### DETAILED DESCRIPTION OF THE PREFERRED EMBODIMENTS

The present invention providing a micro reflection-type liquid crystal display can be exemplified by the preferred embodiments as described hereinafter.

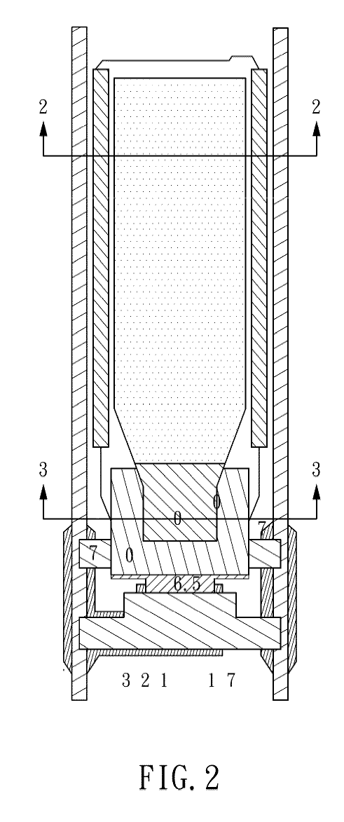

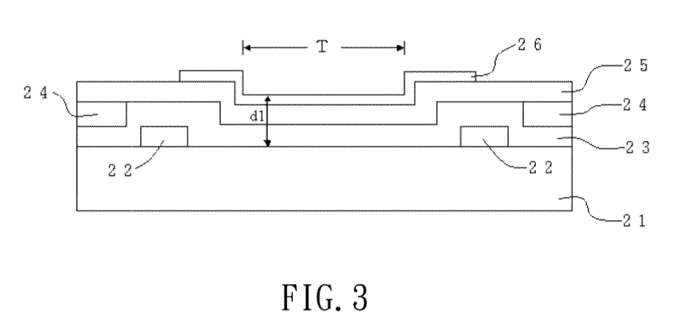

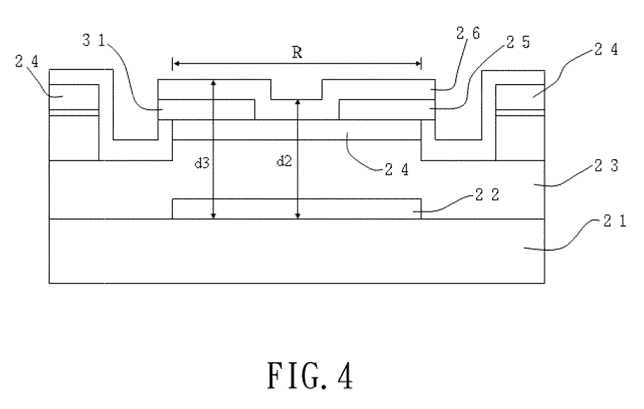

Please refer to FIG. 2, which is a top view of a layout of a sub-pixel of the present invention. The cross-sectional views of a transmissive region T and a reflective region R can be acquired respectively along 2-2 and 3-3 in FIG. 2. In FIG. 3, the transmissive region T is disposed between two metal plates 22 so that the light passes through a glass substrate 21, a gate oxide 23, a passivation layer 25 and a transparent electrode (ITO) 26 in sequence. The thickness d1 of the transmissive region T from the surface of the glass substrate 21 is 7500 Å. The metal plates 24 in FIG. 3 are used as data lines. In FIG. 4, the metal plate 24 is used as a reflection plate in the reflective region R. The metal plate 24 is also used as an electrode plate of a storage capacitor. The thickness d2, d3 of the reflective region R from the surface of the glass substrate 21 is from 9000 to 11500 Å. Therefore, a step difference 46 is defined as the difference between the thicknesses of the transmissive region T and the reflective region R is from 1500 to 4000 Å.

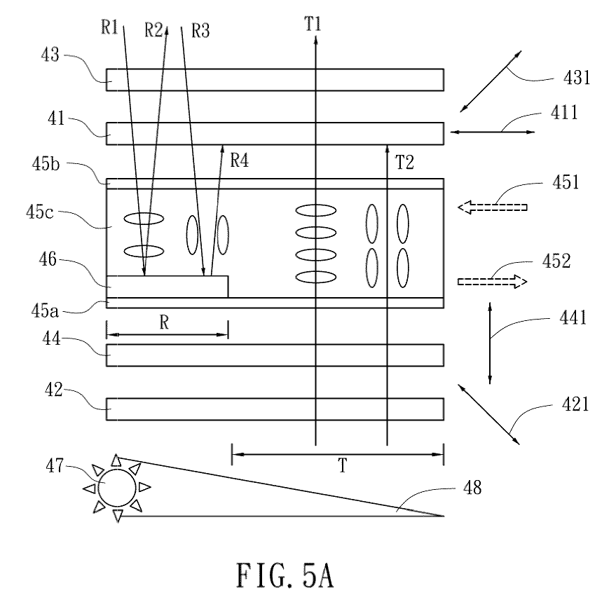

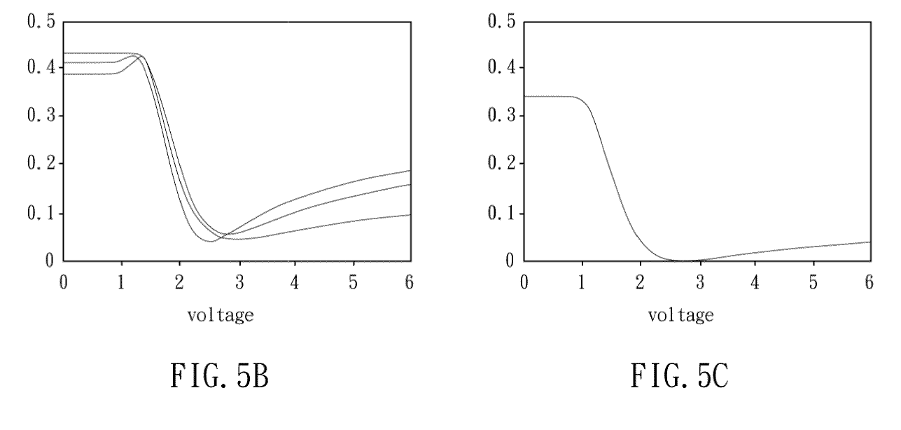

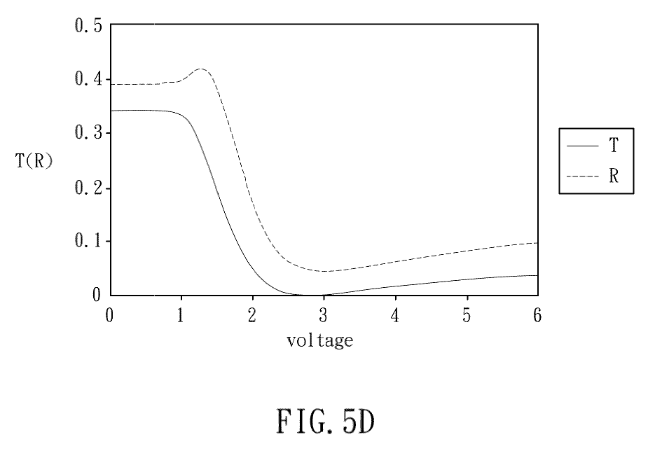

Please refer to FIG. 5A, which is a cross-sectional view of a micro reflection-type thin-film transistor liquid crystal display according to a first embodiment of the present invention. The micro reflection-type liquid crystal display (LCD) comprises a first polarizer 42, a first optical compensation film 44, a liquid crystal cell 45, a second optical compensation film 41, a second polarizer 43 and a backlight module 48. The first optical compensation film 44 is disposed on the first polarizer 42. The liquid crystal cell 45 is disposed on the first optical compensation film 44. The liquid crystal cell 45 comprises a first substrate 45a, a second substrate 45b and a liquid crystal layer 45c. The first substrate 45a comprises a plurality of scan lines and a plurality of data lines, enclosing a plurality of pixel units. Each pixel unit comprises a transmissive region T and a reflective region R. The second substrate 45b is disposed facing the first substrate 45a. A plurality of liquid crystal molecules in the liquid crystal layer 45c are aligned in parallel. The alignment directions 451, 452 of the liquid crystal layer 45c are orthogonal to the direction 441 of a slow axis on the first optical compensation film 44. Therefore, a step difference 46 is defined as the difference between the thicknesses of the transmissive region T and the reflective region R, which results from the existing array processing. The liquid crystal molecules in the liquid crystal layer are aligned in parallel. The second optical compensation film 41 is disposed on the liquid crystal cell 45. The direction 411 of a slow axis on the second optical compensation film 41 is in parallel with the alignment directions 451, 452 the liquid crystal layer. The second polarizer 43 is disposed on the second optical compensation film 41. A backlight module 48 is disposed below the first polarizer 42 and comprises a light source 47. The polarization direction 421 of the first polarizer 42 is orthogonal to the polarization direction 431 of the second polarizer 43.

In a compensation system comprising orthogonal polarizers, the direction 441 of the slow axis on the first optical compensation film 44 and the direction 411 of the slow axis on the second optical compensation film 41 are referred to. When the liquid crystal voltage is off, i.e., the liquid crystal cell 45 is not driven, the liquid crystal molecules in the liquid crystal layer are aligned in parallel in the transmissive region T. Meanwhile, an equivalent retardation approaches a half wavelength (λ/2) to achieve the optimal bright state according to the retardation of the liquid crystal cell 45 in the transmissive region T, the retardation of the first optical compensation film 44 and the retardation of the second optical compensation film 41. When the liquid crystal voltage is on, i.e., the liquid crystal cell 45 is driven, the liquid crystal molecules in the liquid crystal layer are raised vertically in the transmissive region T. Meanwhile, an equivalent retardation approaches zero to achieve the optimal dark state with orthogonal polarizers according to a residual retardation of the liquid crystal cell 45 in the transmissive region T, the retardation of the first optical compensation film 44 and the second optical compensation film 41.

Please refer to FIG. 5B and FIG. 5C for optical simulation results of the first embodiment. FIG. 5B shows the reflectivity at different voltages under the reflection mode according to the first embodiment of the present invention, and FIG. 5C shows the transmission at different voltages under the transmission mode according to the first embodiment of the present invention. In the first embodiment, the direction of a transmission axis on the second polarizer 43 is 45°, the direction of the slow axis on the second optical compensation film 41 is 0° and the retardation of the second optical compensation film 41 is 60 nm. The liquid crystal molecules in the liquid crystal cell are aligned in parallel (homogeneous cell). The alignment direction is downward. The birefringence of the liquid crystal molecules Δn is 0.066. The cell gap in the transmissive region T is 4 μm, while the cell gap in the reflective region R is from 3.6 to 3.85 μm. The direction of the slow axis on the first optical compensation film 44 is 90° and the retardation of the first optical compensation film 44 is 140 nm. The direction of the transmission axis on the first polarizer 42 is 135°. The transmission contrast in the first embodiment is 235, while the reflection contrast is 8.5.

Please refer to FIG. 5D, which shows both the transmission and the reflectivity according to the first embodiment of the present invention. It is observed that the slope of the transmission curve and the slope of the reflection curve are similar, which is helpful in selecting the first grey scale voltage and the final grey scale voltage to provide a proper and common γ value. The optical compensation system in the first embodiment not only achieves lowest dark state but also adopts the same γ value both in the transmission mode and the reflection mode.

The first optical compensation film 44 and the second optical compensation film 41 can be implemented using a hybrid liquid crystalline polymer (LCP) layer. When the retardation of the optical compensation film is from 60 to 190 nm or the alignment direction of the liquid crystal molecules in the hybrid liquid crystalline polymer layer is tilted by a tilt angle from 30° to 70° and the retardation of the hybrid liquid crystalline polymer layer is from 70 to 160 nm, the step difference 46 in the liquid crystal cell 45 is used in the present invention to achieve the foregoing object. Moreover, if the retardation of the liquid crystal cell 45 in the transmissive region T is from 200 to 380 nm and the retardation of the liquid crystal cell 45 in the reflective region is from 100 to 200 nm, the compensation system comprising orthogonal polarizers of the present invention can achieve the foregoing object.

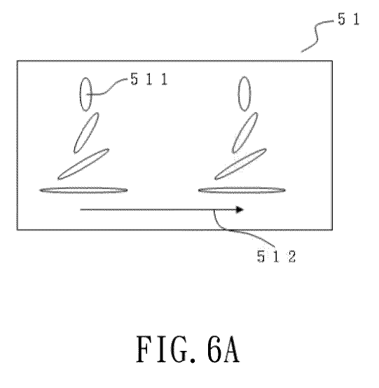

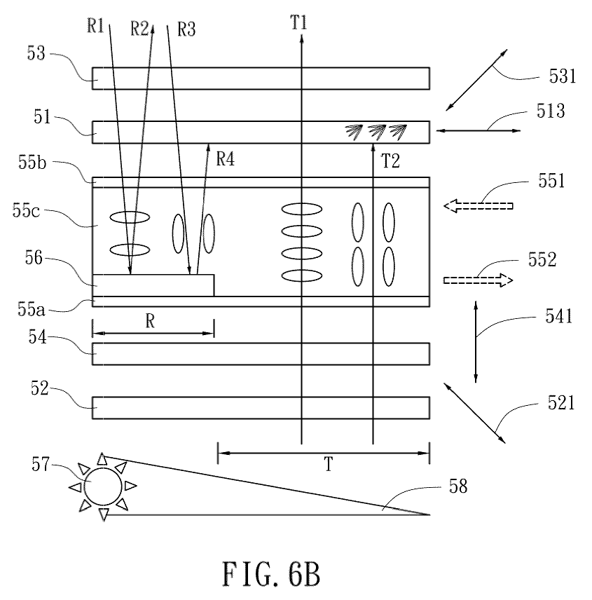

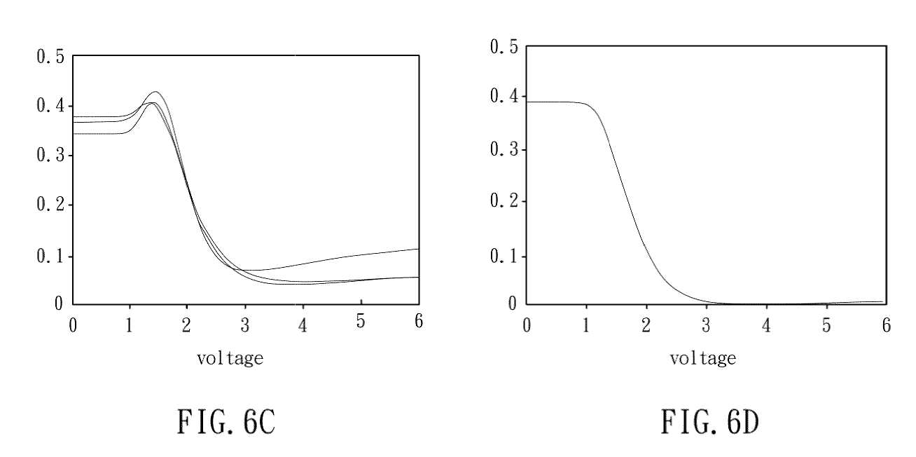

Please refer to FIG. 6A and FIG. 6B for cross-sectional views of a micro reflection-type thin-film transistor liquid crystal display according to a second embodiment of the present invention. In addition to the optical compensation films in the previous embodiment, a hybrid liquid crystalline polymer layer is used to replace any one or both of the two optical compensation films to perform optical compensation in the present embodiment. As shown in FIG. 6A, the liquid crystal molecules 511 in the hybrid liquid crystalline polymer (LCP) layer 51 have the pretilt angle function and there exists the retardation in the hybrid liquid crystalline polymer (LCP) layer 51. The hybrid liquid crystalline polymer layer 51 can be formed by taping or coating. In the present embodiment, the hybrid liquid crystalline polymer layer 51 is formed by taping on the top surface of the liquid crystal cell 55. Alternatively, the hybrid liquid crystalline polymer layer 51 can be formed by coating on the both of the top surface and the bottom surface of the liquid crystal cell 55 to perform optical compensation. Moreover, the hybrid liquid crystalline polymer layer 51 is aligned in the alignment direction 512.

In FIG. 6B, the optical compensation film 54 is disposed on the first polarizer 52. The liquid crystal cell 55 is disposed on the optical compensation film 54. The alignment directions 551, 552 of alignment films (not shown) in a liquid crystal layer 55c are orthogonal to the direction 541 of a slow axis on the first optical compensation film 54. The liquid crystal cell 55 comprises a first substrate 55a, a second substrate 55b and the liquid crystal layer 55c. The first substrate 55a comprises a plurality of scan lines and a plurality of data lines, enclosing a plurality of pixel units. Each pixel unit comprises a transmissive region T and a reflective region R. The second substrate 55b is disposed facing the first substrate 55a. Therefore, a step difference 56 is defined as the difference between the thicknesses of the transmissive region T and the reflective region R, which results from the existing array processing. The liquid crystal molecules in the liquid crystal layer are aligned in parallel (homogeneous cell). The hybrid liquid crystalline polymer layer 51 is disposed on the liquid crystal cell 55. The direction 513 of an optical axis on the hybrid liquid crystalline polymer layer 51 is in parallel with the alignment directions 551, 552 of the alignment films (not shown) in the liquid crystal layer. The second polarizer 53 is disposed on the hybrid liquid crystalline polymer layer 51. A backlight module 58 is disposed below the first polarizer 52 and comprises a light source 57. The direction 521 of the transmission axis on the first polarizer 52 is orthogonal to the direction 531 of the transmission axis on the second polarizer 53.

Please refer to FIG. 6C and FIG. 6D for optical measurement results of the second embodiment. FIG. 6C shows the reflectivity at different voltages under the reflection mode according to the second embodiment of the present invention, and FIG. 6D shows the transmission at different voltages under the transmission mode according to the second embodiment of the present invention. In the second embodiment, the liquid crystal molecules in the liquid crystal cell 55 are aligned in parallel. The alignment direction of the liquid crystal molecules is 90°. The direction of a transmission axis on the second polarizer 53 is 45°, the direction 513 of the optical axis on the hybrid liquid crystalline polymer layer 51 is in parallel with the alignment directions 551, 552 of the alignment films in the liquid crystal cell 55. The retardation of the hybrid liquid crystalline polymer layer 51 is 120 nm and the liquid crystal molecules in the hybrid liquid crystalline polymer layer 51 is tilted by a tilt angle of 50°. The retardation of the liquid crystal cell 55 in the reflective region R is from 240 to 260 nm, and the retardation of the liquid crystal cell 55 in the transmissive region T is 270 nm. The direction of the slow axis on the optical compensation film 54 is 0°, and the retardation of the optical compensation film 54 is 140 nm. The direction of the transmission axis on the first polarizer 52 is 135°. The transmission contrast in the first embodiment is 778, while the reflection contrast is 9.2. It is observed that, in FIG. 6C and FIG. 6D, when the same driving voltage is used both in the transmission mode and the reflection mode, the optical compensation system in the second embodiment achieves the lowest dark state.

Accordingly, in the micro reflection-type liquid crystal display (LCD) of the present invention, a liquid crystal cell comprising liquid crystal molecules being aligned in parallel is used to perform optical compensation according to the retardation difference between slow axes on orthogonal optical compensation films. In a compensation system comprising orthogonal polarizers, a step difference resulting from the existing array processing is used and an equivalent retardation value is acquired according to the differences between the slow axes on the optical compensation films and the alignment orientation of the liquid crystal molecules when the liquid crystal cell is driven or not to determine the optimal dark/bright state. More particularly, an equivalent retardation value approaches a half wavelength (λ/2) to achieve the optimal bright state when the liquid crystal cell is not driven, otherwise an equivalent retardation value approaches zero to achieve the optimal dark state when the liquid crystal cell is driven. Therefore, the optimal dark state can be achieved at the same driving voltage under both the reflection mode and the transmission mode. Thereby, the present invention achieves improved image contrast and reflectivity without additional processing steps.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A micro reflection-type liquid crystal display (LCD), comprising:
a first polarizer;
a first optical compensation film disposed on the first polarizer and comprising a first slow axis;
a liquid crystal cell disposed on the first optical compensation film and comprising:
a first substrate comprising a first alignment film disposed thereon, a plurality of scan lines and a plurality of data lines enclosing a plurality of pixel units, each pixel unit comprising a transmissive region and a reflective region;
a second substrate, comprising a second alignment film disposed thereon and facing the first alignment film;
a liquid crystal layer disposed between the first alignment film and the second alignment film, the liquid crystal layer comprising a plurality of liquid crystal molecules being aligned in parallel, and the first slow axis being perpendicular to the alignment directions of the first and the second alignment films;
a second optical compensation film disposed on the liquid crystal cell and comprising a second slow axis, the second slow axis being parallel with the alignment directions of the first and the second alignment films; and
a second polarizer disposed the second optical compensation film;
wherein the thickness of the liquid crystal layer in the transmissive region is larger than the thickness of the liquid crystal layer in the reflective region, and the retardation in the reflective region is from 110 to 310 nm and the phase retardation in the transmissive region is from 200 to 380 nm.

2. The liquid crystal display as recited in claim 1, further comprising a metal reflection-type layer in the reflective region, the metal reflection-type layer being a top electrode plate of a storage capacitor.

3. The liquid crystal display as recited in claim 2, wherein the metal reflection-type layer further comprising the data lines.

4. The liquid crystal display as recited in claim 1, wherein the retardation of the first optical compensation film is from 60 to 190 nm.

5. The liquid crystal display as recited in claim 1, wherein the retardation of the second optical compensation film is from 60 to 170 nm.

6. The liquid crystal display as recited in claim 1, wherein an equivalent retardation approaches a half wavelength (λ/2) according to the retardation of the liquid crystal layer in the transmissive region, the retardation of the first optical compensation film and the retardation of the second optical compensation film when the liquid crystal cell is not driven.

7. The liquid crystal display as recited in claim 1, wherein the liquid crystal molecules in the transmissive region are vertically aligned and an equivalent retardation approaches zero according to a residual retardation of the liquid crystal layer in the transmissive region, the retardation of the first optical compensation film and the retardation of the second optical compensation film when the liquid crystal cell is driven.

8. The liquid crystal display as recited in claim 7, wherein the angle between a transmission axis on the first polarizer and the first slow axis on the first optical compensation film is 45°, the retardation of the first optical compensation film is 140 nm, the first slow axis on the first optical compensation film is in parallel with the alignment directions of the first and the second alignment films, the birefringence of the liquid crystal molecules is 0.066, the thickness of the liquid crystal layer in the transmissive region is 4 μm, the thickness of the liquid crystal layer in the reflective region is from 3.6 to 3.85 μm, the angle between a transmission axis on the second optical compensation film and a transmission axis on the second polarizer is 45°, the retardation of the second optical compensation film is 60 nm, and the angle between the transmission axis on first polarizer and the transmission axis on the second polarizer is 90°.

9. The liquid crystal display as recited in claim 1, wherein at least one of the first and the second optical compensation films is a hybrid liquid crystalline polymer (LCP) layer.

10. The liquid crystal display as recited in claim 9, wherein the transmission axis on the first polarizer and the transmission axis on the second polarizer are orthogonal, the alignment direction of liquid crystal molecules in the hybrid liquid crystalline polymer layer is in parallel with the alignment directions of the alignment films in the liquid crystal layer, the retardation of the hybrid liquid crystalline polymer layer is 120 nm, the liquid crystal molecules in the hybrid liquid crystalline polymer layer are tilted by a tilt angle of 50°, the retardation of the other one of the first and the second optical compensation films is 140 nm, and the angle between the slow axis of the other one of the first and the second optical compensation films and the transmission axis on the second polarizer is 45°.

11. The liquid crystal display as recited in claim 9, wherein the transmission axis on the first polarizer and the transmission axis on the second polarizer are orthogonal, the alignment direction of liquid crystal molecules in the hybrid liquid crystalline polymer layer is vertical to the alignment directions of the alignment films in the liquid crystal layer, the retardation of the hybrid liquid crystalline polymer layer is 120 nm, the liquid crystal molecules in the hybrid liquid crystalline polymer layer are tilted by a tilt angle of 50°, the retardation of the other one of the first and the second optical compensation films is 140 nm, and the angle between the slow axis of the other one of the first and the second optical compensation films and the transmission axis on the second polarizer is 45°.
